(19) United States
(12) Patent Application Publication
(10) Pub. No.: US 2016/0337918 A1
(43) Pub. Date: Nov. 17, 2016

(54) METHOD AND DEVICE FOR MANAGING RADIO ACCESS POINTS

(71) Applicants: David BROCK, Cambridgeshire (GB); IP.ACCESS LIMITED, Cambridge, (GB)

(72) Inventor: David Brock, Cambridge (GB)

(21) Appl. No.: 15/105,077

(22) PCT Filed: Nov. 13, 2014
(86) PCT No.: PCT/EP2014/074431

§ 371 Date: Jun. 16, 2016

(30) Foreign Application Priority Data
Dec. 23, 2013 (GB) 1322921.6

(51) Int. Cl. H04W 36/04

(52) U.S. Cl. CPC H04W 36/04; H04W 84/045

(57) ABSTRACT

The invention facilitates the implementation of clusters of small cells or radio heads or Home Node Bs (HNB) (102, 103, 104) managed by a local standard-Iuh enterprise gateway, connected to a standard release 8/9 HNB-GW. The enterprise gateway sends an HNB Registration Request corresponding to each small cell or radio head that it manages to a Home Node B Gateway over the standard Iuh interface, thereby presenting a single logical interface to the Home Node B Gateway (HNB-GW) that appears to the HNB-GW as a collection of Iuh-standard HNBs. This provides the enterprise gateway with a set of call processing and radio resources that it can implement as it wishes, but using standard messaging to control the HNBGW's view of those resources. A further advantage of the invention is the ability to permit hand-in of a user equipment from a macrocell to a small cell.

### FIELD OF THE INVENTION

The field of this invention relates to a method and a device for managing a plurality of radio access points in small cell wireless communications networks.

### BACKGROUND OF THE INVENTION

Wireless communication systems, such as the 3^{rd} Generation (3G) of mobile telephone standards and technology, are well known. An example of such 3G standards and technology is the Universal Mobile Telecommunications System (UMTS™), developed by the 3rd Generation Partnership Project (3GPP™) (www.3gpp.org). The 3^{rd} generation of wireless communications has generally been developed to support macro-cell mobile phone communications. Such macrocells utilise high power base stations (NodeBs in 3GPP parlance) to communicate with wireless communication units within a relatively large geographical coverage area. Typically, wireless communication units, or User Equipment (UEs) as they are often referred to in 3G parlance, communicate with a Core Network (CN) of the 3G wireless communication system via a Radio Network Subsystem (RNS). A wireless communication system typically comprises a plurality of radio network subsystems, each radio network subsystem comprising one or more cells to which UEs may attach, and thereby connect to the network. Each macro-cellular RNS further comprises a controller, in a form of a Radio Network Controller (RNC), operably coupled to the one or more Node Bs, via a so-called Iub interface.

The second generation wireless communication system (2G), also known as GSM, is a well-established cellular, wireless communications technology whereby “base transceiver stations” (equivalent to the Node B's of the 3G system) and “mobile units” (user equipment) can transmit and receive voice and packet data. Several base transceiver stations are controlled by a Base Station Controller (BSC), equivalent to the RNC of 3G systems.

Communications systems and networks are developing towards a broadband and mobile system. The 3rd Generation Partnership Project has proposed a Long Term Evolution (LTE) solution, namely, an Evolved Universal Mobile Telecommunication System Territorial Radio Access Network, (E-UTRAN), for a mobile access network, and a System Architecture Evolution (SAE) solution, namely, an Evolved Packet Core (EPC), for a mobile core network. An evolved packet system (EPS) network provides only packet switching (PS) domain data access so a voice service is provided by a 2G or 3G Radio Access Network (RAN) and circuit switched (CS) domain network. User Equipment (UE) can access a CS domain core network through a 2G/3GRAN such as the (Enhanced Data Rate for GSM Evolution, EDGE) Radio Access Network (Radio Access Network, GERAN) or a Universal Mobile Telecommunication System Terrestrial Radio Access Network (Universal Mobile Telecommunication System Terrestrial Radio Access Network, UTRAN), and access the EPC through the E-UTRAN. Generally, the Core Network is responsible for switching and routing voice calls and data to and from wired telephone networks or the Internet. A RAN is located between the Core Network and the UE.

Lower power (and therefore smaller coverage area) cells are a recent development within the field of wireless cellular communication systems. Such small cells are effectively communication coverage areas supported by low power base stations. The terms “picocell” and “femtocell” are often used to mean a cell with a small coverage area, with the term femtocell being more commonly used with reference to residential small cells. Herein, the term “small cell” means any cell having a small coverage area and includes “picocells” and femtocells. The low power base stations which support small cells are referred to as Access points (AP's) with the term Home Node B (HNB's) or Evolved Home Node B (eHNB) identifying femtocell access points. These small cells are intended to augment the wide area macro network and support communications to User Equipments in a restricted, for example, indoor environment. An additional benefit of small cells is that they can offload traffic from the macro network, thereby freeing up valuable macro network resources.

Typical applications for such Access Points include, by way of example, residential and commercial locations, communication ‘hotspots’, etc., whereby Access Points can be connected to a core network via, for example, the Internet using a broadband connection or the like. In this manner, femto cells can be provided in a simple, scalable deployment in specific in-building locations where, for example, network congestion at the macro-cell level may be problematic.

Thus, an AP is a scalable, multi-channel, two-way communication device that may be provided within, say, residential and commercial (e.g. office) locations, ‘hotspots’ etc, to extend or improve upon network coverage within those locations.

A HNB provides a radio access network connectivity to a user equipment (UE) using the so-called Iuh interface to a network Access Controller, also known as a Home Node B Gateway (HNB-GW). A HNB-GW is connected to the Core Network via the so-called Iu interface.

Increasingly, APs are being deployed by enterprises and by Mobile Communications Operators within enterprises' premises. Such enterprises may be, for example, large corporations that want to extend mobile communication capabilities inside their own buildings and other facilities where conventional cellular services provided by a macrocell might not be available or are less desirable from a cost perspective. US2012/0196594 discloses a wireless communication network including an “enterprise controller” which is configured to service a plurality of access points and to map messages to appropriate APs that it services. The enterprise controller is connected with a HNB-GW. In one mode of operation, the enterprise controller registers with the HNB-GW and receives a registration request from each AP that it services. The enterprise controller then generates a data map that comprises a list of registered APs, sends the data map to the HNB-GW so that the HNB-GW is aware of those AP devices that are serviced by the enterprise controller. The HNB-GW, thus, can send messages destined for multiple user equipments managed the APs by sending aggregated messages to the enterprise controller. However, this arrangement has the disadvantage of requiring modifications to a standard HNB-GW and also, therefore, a modification to the standard Iuh interface. In another mode of operation, the enterprise controller receives a first registration request from a first UE managed by a first AP and a second registration request from a second UE managed by a second AP. The enterprise controller forwards the first and second registration requests to the HNB-GW and, subsequently, signals to the HNB-GW that the first and second UE devices are relocating to a third AP but without the first and second UEs having sent registration requests for such relocating. The enterprise controller itself may act as the third AP. The HNB-GW, thus, can send messages destined for the first UE and second UE by sending aggregated messages to the third AP (ie. the enterprise controller).This arrangement has the disadvantage that a handover of a user equipment from a neighbouring macrocell to one of the APs is not possible because the HNB-GW does not know the identity of the AP to which a user equipment is requesting a handover.

Thus, it would be advantageous to be able to provide an “enterprise controller” or “enterprise gateway” which did not present these disadvantages.

### SUMMARY OF THE INVENTION

Aspects of the invention provide an enterprise gateway device, a wireless communication system and methods therefor as described in the appended claims.

According to a first aspect of invention there is provided an enterprise gateway device for managing a plurality of radio access points in a small cell wireless communications network, wherein the enterprise gateway device includes a memory for storing an identification parameter of each of said plurality of radio access points, and a signal processing module for sending a registration request in respect of each of the plurality of radio access points to a gateway device over a standard Iuh interface.

The gateway device may be a standard Home Node B Gateway.

An identification parameter of each radio access point may comprise an identifier unique to each radio access point, for example, a cell ID. Other identification parameters associated with a radio access point which may be stored in the memory may include a PLMN (Public Land Mobile Network) ID, a LAC (location area code), a RAC (routing area code). The memory may be pre-provisioned with at least one identification parameter in respect of each radio access point being managed by the enterprise gateway or alternatively, the parameters may be transmitted by a radio access point, received by the signal processing module and stored in the memory.

In one embodiment, at least one radio access point is a Home Node B and the signal processing module in the enterprise gateway device is arranged to receive from the Home Node B a HNB Registration Request and to forward this to the gateway device.

In another embodiment, the radio access point may not follow the standard architecture for a HNB and be incapable of generating the standard HNB Registration Request. In such a case, it may be generated by the signal, processing module in the enterprise gateway itself on receiving a non-standard request for registration from the radio access point. The signal processing module may then send the generated HNB Registration Request to the gateway device.

In this way a “logical” HNB which is managed by the enterprise gateway device may be registered with a HNB-GW (and ultimately with a core network)

According to a second aspect of the invention, there is provided a method for managing a plurality of radio access points in a small cell wireless communications network wherein the method comprises; storing an identification parameter of each of said plurality of radio access points, and sending a registration request in respect of each of the plurality of radio access points to a gateway device over a standard Iuh interface.

The invention can, advantageously, provide a way of aggregating many HNBs (or access points supporting a small cell), or logical HNBs, on a common interface, using standard Iuh messaging with no modifications to a standard Home Node B Gateway being required. The invention allows a single device such as an “enterprise gateway” (EG) or other aggregation device to present a single logical interface to a Home Node B Gateway (HNBGW) that appears to the HNB-GW as a collection of iuh-standard HNBs. This provides the enterprise gateway with a set of call processing and radio resources that it can implement as it wishes, but using standard messaging to control the HNB-GW's view of those resources, modelled as HNBs

Further, the invention allows the presence of an aggregation device and hides the local radio implementation architecture, while using entirely standard HNB procedures towards a HNB-GW. In one example, a standard-Iuh-compatible EG models its RF resources as if they were a collection of HNBs, each with PLMN-ID, Cell-ID, LAC, RAC etc

As such, with no change to HNBAP/RUA messaging or the HNB-GW, the standard-Iuh EG can register its resources and perform normal HNB call processing, while having the capability to implement and coordinate its radio resources in any way it sees fit, provided all internal procedures are mediated to standard Iuh procedures.

A further advantage of the invention is the ability to permit hand-in of a user equipment (that is, a handover from a macrocell to a small cell). As the enterprise gateway EG registers all “logical ” HNBs (or radio access points) with the Iuh HNB-GW and the incoming handover request carries a target cell ID (as is usual), a standard, unmodified HNB-GW can directly relay the request to the logical HNB/radio access point associated with the Cell ID (via the EG).

According to a third aspect of the invention there is provided a wireless communication system arranged to support the method and the enterprise gateway device of the above aspects.

According to a fourth aspect of the invention, there is provided a tangible computer program product having executable program code stored thereon for execution by a processor to perform a method in accordance with the second aspect.

The tangible computer program product may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory

These and other aspects, features and advantages of the invention will be apparent from, and elucidated with reference to, the embodiments described hereinafter.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale. Like reference numerals have been included in the respective drawings to ease understanding.

FIG. 1 is a schematic diagram of a wireless communication system comprising an enterprise gateway device operating in accordance with embodiments of the invention; and

FIG. 2 is a message sequence chart of an example embodiment of a method for managing a plurality of access points.

### DETAILED DESCRIPTION

The inventive concept finds particular applicability in wireless communication systems which include small cell networks.

Those skilled in the art will recognise and appreciate that the specifics of the specific examples described are merely illustrative of some embodiments and that the teachings set forth herein are applicable in a variety of alternative settings. For example, implementations within cellular communication systems conforming to different standards are contemplated and are within the scope of the various teachings described.

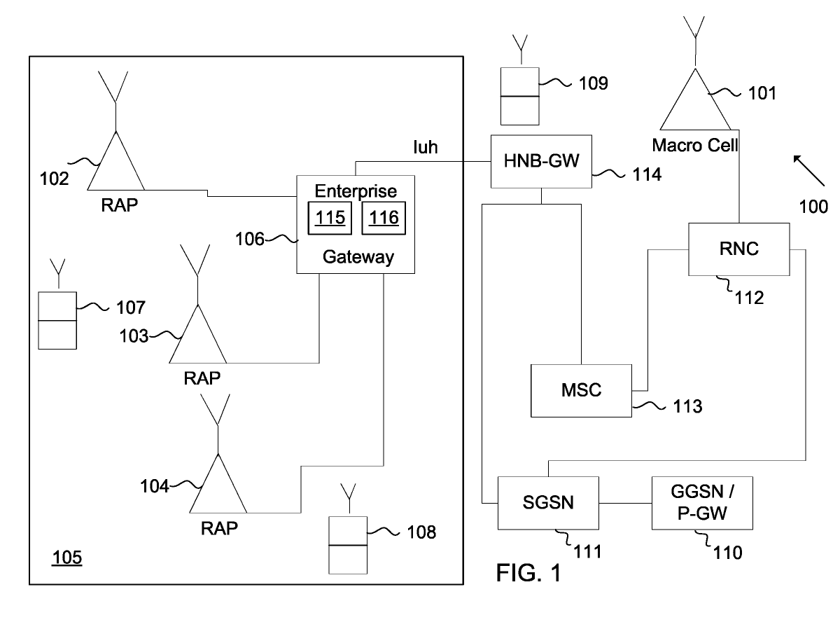

Referring now to FIG. 1, an example of a wireless communication system operating in accordance with some embodiments of the invention is illustrated and indicated generally at 100.

The system 100 comprises a macrocell base station (or node B) 101 and three radio access points (RAP) 102, 103, 104 which provide cellular, wireless communications services to user equipments within their respective coverage areas. The RAPs 102, 103 and 104 are located within a building 105 and are all connected to and managed by an enterprise gateway (EG) 106, also located within the building 105. Although three RAPs are shown in FIG. 1, more or less RAPs may be provided in the building 105. Three user equipments 107, 108, 109 are shown in FIG. 1 which may receive services provided by a core network via the macrocell base station 101 or any of the RAPs 102, 103, 104.

A core network of the wireless communication system of FIG. 1 includes a Gateway General Packet Radio System (GPRS) Support Node (GGSN) 110 and a Serving GPRS Support Node (SGSN) 111. The GGSN 110 or SGSN 111 is responsible for interfacing the wireless communication system 100 with a packet data network, for example a Public Switched Data Network (PSDN), (such as the Internet) or a Public Switched Telephone Network (PSTN). The SSGN 111 performs a routing and tunnelling function for traffic to and from any of the cells supported by the APs 102, 103, 104 or the macrocell base station 101 while the GGSN 110 links with external packet networks. In an Evolved Packet Core, the equivalent node to a GSGN is a Packet Gateway (P-GW). The macrocell base station 101 is controlled by a radio network controller (RNC) 112. The RNC 112 is linked to the SGSN 111 and to a mobile switching centre 113. The MSC 113 is also linked to a Home Node B Gateway HNB-GW 114. The HNB-GW is a standard HNB-GW and is also linked to the enterprise gateway EG 106 over a standard Iuh interface. The link may be typically provided by broadband Internet or wide area connection, for example.

The EG 106 includes a memory 115 and a signal processing module 116, arranged to receive registration requests from each RAP 102, 103, 104 and to forward the requests to the HNB-GW 114. The signal processing module is also arranged to receive at least one identification parameter from each RAP 102, 103, 104 and store them in the memory 115.

In one embodiment, the RAPs may comprise Home Node Bs. Although there are no standard criteria for the functional components of a HNB, an example of a typical HNB for use within a 3GPP 3G system may comprise Node-B functionality and some aspects of Radio Network Controller (RNC) functionality as specified in 3GPP TS 25.467. A typical HNB also incorporates transmitting and receiving circuitry for enabling communication with User Equipments via the wireless interface. Hence the RAPs 102, 103, 104 can be configured to act in a similar way to normal HNBs, but for example sharing and coordinating backhaul resources without any support from the Iuh HNB-GW.

In some embodiments of the invention, some of the functionality of a Home Node B may be incorporated in the EG 106 instead and at least one of the RAPs 102, 103, 104 may have just a radio capability; ie. have little more intelligent functionality than an antenna. This is another advantage of the invention; providing design flexibility of a small cell system whereby the enterprise gateway can be configured to co-ordinate radio resources, for the purposes of minimising interference between RAPs, for example. In another example of the invention, the enterprise gateway may be used to set frequencies and power levels for each RAP that it manages. Thus, interference management may be superior to that achieved by HNBs alone without the benefit of the managing enterprise gateway EG.

This additional design flexibility provided by the incorporation of the enterprise gateway (EG) enables the EG and RAPs to perform other co-ordination functions, such as soft handover, that are not readily achieved by independent HNBs (which are not managed by the EG).

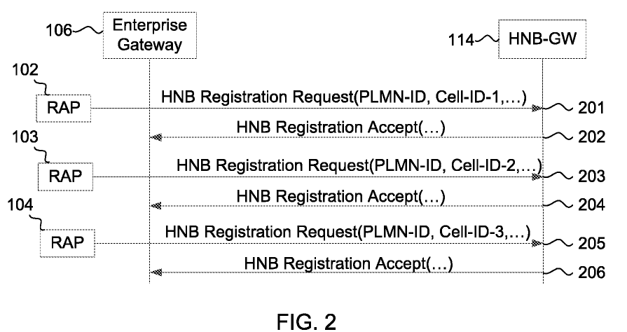

Some methods of operation of the embodiment of FIG. 1 will now be described with reference to the message sequence chart of FIG. 2. The enterprise gateway (EG) receives requests for registration from first, second and third radio access points (RAP) 102, 103, 104. The enterprise gateway stores in its memory, identification parameters of each radio access point which in one example include a cell ID and PLMN ID. At 201, the enterprise gateway sends a HNB Registration Request in respect of the first radio access point 102 to the HNB-GW 114. The HNB Registration Request includes the cell ID in respect of the first radio access point (cell ID-1) and the PLMN ID. At 202, the HNB-GW sends a HNB Registration Accept message back to the enterprise gateway in respect of the first radio access point. At 203, the enterprise gateway sends a HNB Registration Request in respect of the second radio access point 103 to the HNB-GW 114. This HNB Registration Request includes the PLMN ID and cell ID (cell ID-2) in respect of the second radio access point 103. In response, at 204, the HNB-GW sends a HNB Registration Accept message in respect of the second radio access point to the enterprise gateway 106. At 205, the enterprise gateway sends a HNB Registration Request in respect of the third radio access point 104 to the HNB-GW. This HNB Registration Request includes the PLMN ID and the cell ID (cell ID-3) in respect of the third radio access point. In response, at 206, the HNB-GW sends a HNB Registration Accept message in respect of the third radio access point to the enterprise gateway. Hence, the enterprise gateway presents a single logical interface to the HNB-GW but it appears to the HNB-GW as a collection of (three) standard HNBs. The HNB Registration Request can also include a LAC and a RAC. The LAC and RAC may be shared by all three radio access points.

Referring again to FIG. 1, consider the case where the User Equipment UE 109 is currently connected to the macrocell serviced by the macrocell base station 101 but moving into the building 105 and closer to the radio access point 102. As the UE carries out its conventional measurements on neighbouring cells' broadcast signals under the control of the RNC 112, the RNC determines that the radio access point 102 is a good candidate for a handover from the macrocell base station. This because, the UE is moving out of the coverage range of the macrocell and into that of the small cell serviced by the RAP 102. Using standard messaging, the RNC 112 sends a request for handover, (for example, a “RANAP Relocation Required,” sent to the MSC) which includes the identity of the cell that it wishes to handover to, (that is in this example, the cell serviced by RAP 102, which is managed by the enterprise gateway). Again, using standard messaging this request is promulgated through the core network and results in a request for handover being received at the HNB-GW 114. As the enterprise gateway has registered the RAP 102 with the HNB-GW and its cell ID is known to the HNB-GW 114, the HNB-GW can forward the messages necessary for completing the handover process to the enterprise gateway. On receiving these messages from the HNB-GW, the enterprise gateway consults its memory 115 to determine which of the radio access points that it services is the one identified by the UE 109 and RNC 112 as the handover candidate. The enterprise gateway 106 can then route any messages associated with the UE 109 to the radio access point 102. As the LAC associated with the RAP102 is also known to the HNB-GW, the HNB-GW can forward any future paging messages destined for the UE 109 to the enterprise gateway 106.

The signal processing functionality of the embodiments of the invention, particularly the function of the signal processor 116, may be achieved using computing systems or architectures known to those who are skilled in the relevant art. Computing systems such as, a desktop, laptop or notebook computer, hand-held computing device (PDA, cell phone, palmtop, etc.), mainframe, server, client, or any other type of special or general purpose computing device as may be desirable or appropriate for a given application or environment can be used. The computing system can include one or more processors which can be implemented using a general or special-purpose processing engine such as, for example, a microprocessor, microcontroller or other control module.

The computing system can also include a main memory, such as random access memory (RAM) or other dynamic memory, for storing information and instructions to be executed by a processor. Such a main memory also may be used for storing temporary variables or other intermediate information during execution of instructions to be executed by the processor. The computing system may likewise include a read only memory (ROM) or other static storage device for storing static information and instructions for a processor.

The computing system may also include an information storage system which may include, for example, a media drive and a removable storage interface. The media drive may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media may include, for example, a hard disk, floppy disk, magnetic tape, optical disk, CD or DVD, or other fixed or removable medium that is read by and written to by media drive. The storage media may include a computer-readable storage medium having particular computer software or data stored therein.

In alternative embodiments, an information storage system may include other similar components for allowing computer programs or other instructions or data to be loaded into the computing system. Such components may include, for example, a removable storage unit and an interface, such as a program cartridge and cartridge interface, a removable memory (for example, a flash memory or other removable memory module) and memory slot, and other removable storage units and interfaces that allow software and data to be transferred from the removable storage unit to computing system.

The computing system can also include a communications interface. Such a communications interface can be used to allow software and data to be transferred between a computing system and external devices. Examples of communications interfaces can include a modem, a network interface (such as an Ethernet or other NIC card), a communications port (such as for example, a universal serial bus (USB) port), a PCMCIA slot and card, etc. Software and data transferred via a communications interface are in the form of signals which can be electronic, electromagnetic, and optical or other signals capable of being received by a communications interface medium.

In this document, the terms ‘computer program product’, ‘computer-readable medium’ and the like may be used generally to refer to tangible media such as, for example, a memory, storage device, or storage unit. These and other forms of computer-readable media may store one or more instructions for use by the processor comprising the computer system to cause the processor to perform specified operations. Such instructions, generally referred to as ‘computer program code’ (which may be grouped in the form of computer programs or other groupings), when executed, enable the computing system to perform functions of embodiments of the present invention. Note that the code may directly cause a processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system using, for example, removable storage drive. A control module (in this example, software instructions or executable computer program code), when executed by the processor in the computer system, causes a processor to perform the functions of the invention as described herein.

Furthermore, the inventive concept can be applied to any circuit for performing signal processing functionality within a network element. It is further envisaged that, for example, a semiconductor manufacturer may employ the inventive concept in a design of a stand-alone device, such as a microcontroller of a digital signal processor (DSP), or application-specific integrated circuit (ASIC) and/or any other sub-system element.

It will be appreciated that, for clarity purposes, the above description has described embodiments of the invention with reference to a single processing logic. However, the inventive concept may equally be implemented by way of a plurality of different functional units and processors to provide the signal processing functionality. Thus, references to specific functional units are only to be seen as references to suitable means for providing the described functionality, rather than indicative of a strict logical or physical structure or organisation.

Aspects of the invention may be implemented in any suitable form including hardware, software, firmware or any combination of these. The invention may optionally be implemented, at least partly, as computer software running on one or more data processors and/or digital signal processors or configurable module components such as FPGA devices. Thus, the elements and components of an embodiment of the invention may be physically, functionally and logically implemented in any suitable way. Indeed, the functionality may be implemented in a single unit, in a plurality of units or as part of other functional units.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

1-12. (canceled)

13. An enterprise gateway device for managing a plurality of radio access points in a small cell wireless communications network wherein the enterprise gateway device includes a memory configured to store an identification parameter of each of said plurality of radio access points, and a signal processing module configured to send a registration request in respect of each of the plurality of radio access points to a gateway device over a standard Iuh interface, thereby presenting a single logical interface to the gateway device that appears as a collection of Iuh-standard Home Node Bs.

14. The enterprise gateway device of claim 13, wherein the gateway device is an aggregation device configured to hide local radio implementation architecture, whilst using standard HNB procedures towards a Home Node B Gateway.

15. The enterprise gateway device of claim 13, wherein at least one radio access point is a Home Node B and the signal processing module is arranged to receive from the Home Node B a HNB Registration Request and to forward the HNB Registration Request to the gateway device.

16. The enterprise gateway device of claim 13, wherein at least one radio access point does not follow the standard architecture for a Home Node B and the signal processing module is arranged to receive from said at least one radio access point a non-standard request for registration and to generate a HNB Registration Request in respect of said at least one radio access point and to send said generated HNB Registration Request to the gateway device.

17. The enterprise gateway device of claim 13, wherein the signal processing module is arranged to receive at least one identification parameter from at least one of said plurality of radio access points and store it in the memory.

18. The enterprise gateway device of claim 13, wherein an identification parameter uniquely identifies a radio access point.

19. A method for managing a plurality of radio access points in a small cell wireless communications network wherein the method comprises; in an enterprise gateway device:
storing an identification parameter of each of said plurality of radio access points; and
sending a registration request in respect of each of the plurality of radio access points to a gateway device over a standard Iuh interface, thereby presenting a single logical interface to the gateway device that appears as a collection of Iuh-standard Home Node Bs.

20. The method of claim 19, wherein at least one radio access point is a Home Node B, and the method further comprises receiving from the Home Node B a HNB Registration Request and to forward the HNB Registration Request to the gateway device.

21. The method of claim 19, wherein the method further comprises:
receiving from said at least one radio access point a non-standard request for registration;
generating a HNB Registration Request in respect of said at least one radio access point; and
sending said generated HNB Registration Request to the gateway device.

22. The method of claim 19, wherein an identification parameter is a cell ID uniquely identifying a first radio access point, the method further comprising:
handing over a user equipment from a macrocell to a small cell supported by the first access point, and in the gateway device,
receiving a request for handing over the user equipment from the macrocell to a cell having said cell ID and in response,
sending a handover message to the enterprise gateway, and
in the enterprise gateway, forwarding a handover message to the first radio access point.

23. A wireless communication system comprising an enterprise gateway device for managing a plurality of radio access points in a small cell wireless communications network wherein the enterprise gateway device includes a memory configured to store an identification parameter of each of said plurality of radio access points, and a signal processing module configured to send a registration request in respect of each of the plurality of radio access points to a gateway device over a standard Iuh interface, thereby presenting a single logical interface to the gateway device that appears as a collection of Iuh-standard Home Node Bs.

24. The wireless communication system of claim 23, wherein the enterprise gateway device is an aggregation device configured to hide local radio implementation architecture, whilst using standard HNB procedures towards a Home Node B Gateway.

25. The wireless communication system of claim 23, wherein at least one radio access point is a Home Node B and the signal processing module is arranged to receive from the Home Node B a HNB Registration Request and to forward the HNB Registration Request to the gateway device (114).

26. The wireless communication system of claim 23, wherein at least one radio access point does not follow the standard architecture for a Home Node B and the signal processing module (116) is arranged to receive from said at least one radio access point a non-standard request for registration and to generate a HNB Registration Request in respect of said at least one radio access point and to send said generated HNB Registration Request to the gateway device.

27. The wireless communication system of claim 23, wherein the signal processing module is arranged to receive at least one identification parameter from at least one of said plurality of radio access points and store it in the memory.
